(19) United States
(12) Patent Application Publication
(10) Pub. No.: US 2009/0130520 A1
(43) Pub. Date: May 21, 2009

(54) FUEL BATTERY

(75) Inventors: Tomohiro Ogawa, Shizuoka-ken (JP); Kimihide Horio, Aichi-ken (JP); Masaru Tsunokawa, Aichi-ken (JP); Ikuyasu Kato, Aichi-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignees: TOYOTA JIDOSHA KABUSHIKI KAISHA, Toyota-shi, Aichi-ken (JP); NIPPON SOKEN, INC., Nishio-shi, Aichi (JP)

(21) Appl. No.: 12/305,209

(22) PCT Filed: Oct. 18, 2007
(86) PCT No.: PCT/JP2007/070322

§ 371 Date: Dec. 17, 2008

(30) Foreign Application Priority Data
Oct. 19, 2006 (JP) 2006-285258

(51) Int. Cl. H01M 8/10

(52) U.S. Cl. 429/30

(57) ABSTRACT

A fuel cell that can prevent local accumulation of a reaction-irrelevant gas in the fuel cell. A gas diffusion layer is stacked on a membrane electrode assembly, which is a stack of an electrolyte membrane and electrode catalyst layers. A separator including gas flow channels is attached to the gas diffusion layer such that the gas flow channels are adjacent to the gas diffusion layer. A gas distribution channel through which gas supplied to the membrane electrode assembly flows is formed in the separator. The gas flow channels communicate with the gas distribution channel at upstream ends thereof and are substantially closed at downstream ends thereof. The gas flow channels are configured so that downstream parts of the gas flow channels and upstream parts of the gas flow channels are adjacent to each other.

### TECHNICAL FIELD

The present invention relates to a fuel cell.

### BACKGROUND ART

As disclosed in Japanese Patent Laid-Open No. 2005-116205, there is known a fuel cell that has a plurality of anode gas supply ports for supplying a reactive gas, confines the reactive gas in the anode, and opens and closes the anode gas supply ports as required. The fuel cell generates electric power by an electrochemical reaction of hydrogen in a hydrogen-rich reactive gas supplied to the anode. According to the conventional technique described above, since the reactive gas is confined in the anode during electric power generation, the reactive gas can be efficiently used.

For efficient electric power generation, it is preferred that the gas distribution in the fuel cell is substantially uniform, and hydrogen is distributed in the anode in a balanced manner. However, when the reactive gas is supplied through a fixed anode gas supply port, the direction of flow of the reactive gas is also fixed. As a result, as the reactive gas flows, gas that is not irrelevant to the reaction for electric power generation (reaction-irrelevant gas), such as nitrogen and water vapor, can be carried downstream, and the concentration of the reaction-irrelevant gas can locally increase at the downstream position (the reaction-irrelevant gas can be locally concentrated at the downstream position).

In such a case, the gas distribution in the fuel cell undesirably becomes nonuniform. Thus, for the conventional fuel cell described above, the open/close state of the anode gas supply ports is controlled separately to appropriately change the point of supply of the reactive gas, thereby making the gas distribution in the fuel cell more uniform.

Patent Document 1: Japanese Patent Laid-Open No. 2005-116205

Patent Document 2: Japanese Patent Laid-Open No. 2001-126746

### DISCLOSURE OF THE INVENTION

### Problem to be Solved by the Invention

As described above, there is a demand for a technique of reducing the nonuniformity of the concentration of a gas in a fuel cell and making the distribution of the concentration of the gas in the fuel cell uniform. Through the earnest study of the problem, the present inventor has devised a novel technique of preventing local accumulation of a reaction-irrelevant gas.

The present invention has been made to solve the problem described above, and an object of the present invention is to provide a fuel cell that can prevent local accumulation of a reaction-irrelevant gas in the fuel cell.

### Means for Solving the Problem

To achieves the above-mentioned purpose, the first aspect of the present invention is a fuel cell comprising:

a membrane electrode assembly;

a gas diffusion layer stacked on said membrane electrode assembly;

one or more gas flow channels formed adjacent to said gas diffusion layer; and

a gas supply channel through which gas supplied to said gas flow channels flows, said gas flow channels communicating with said gas supply channel at the upstream ends thereof and being substantially closed at downstream ends thereof,

characterized in that a downstream part of a gas flow channel of said gas flow channels is adjacent to an upstream part of the gas flow channel or an upstream part of another gas flow channel of said gas flow channels.

The second aspect of the present invention is the fuel cell according to the first aspect of the present invention, characterized in that the downstream end of a gas flow channel of said gas flow channels is adjacent to the upstream end of the gas flow channel or the upstream end of another gas flow channel of said gas flow channels.

The third aspect of the present invention is the fuel cell according to the first aspect of the present invention or the second aspect of the present invention, characterized in that said gas supply channel includes a first gas supply channel and a second gas supply channel that are disposed with said gas diffusion layer interposed therebetween in the direction of the plane of said membrane electrode assembly,

said gas flow channels include a first gas flow channel that communicates with said first gas supply channel at the upstream end thereof and is substantially closed at the downstream end thereof and a second gas flow channel that communicates with said second gas supply channel at the upstream end thereof and is substantially closed at the downstream end thereof, and

an upstream part of said first gas flow channel and a downstream part of said second gas flow channel are adjacent to each other, and a downstream part of the first gas flow channel and an upstream part of the second gas flow channel are adjacent to each other.

The fourth aspect of the present invention is the fuel cell according to the third aspect of the present invention, characterized in that said first gas flow channel and said second gas flow channel are disposed alternately.

The fifth aspect of the present invention is the fuel cell according to the first aspect of the present invention or the second aspect of the present invention, characterized in that said gas flow channel has a folded part between said upstream part and said downstream part, and

the downstream part of the gas flow channel is adjacent to the upstream part of the gas flow channel.

The sixth aspect of the present invention is the fuel cell according to any one of the first aspect of the present invention to the fifth aspect of the present invention, characterized in that said gas flow channel is completely closed at the downstream end thereof.

The seventh aspect of the present invention is the fuel cell according to any one of the first aspect of the present invention to the fifth aspect of the present invention, characterized in that the fuel cell further comprises:

a gas discharge channel connected to said downstream end; and

a purge valve that is disposed in said gas discharge channel and is capable of being opened and closed to switch the state of communication of the gas discharge channel.

The eighth aspect of the present invention is the fuel cell according to any one of the first aspect of the present invention to the fifth aspect of the present invention, characterized in that the fuel cell further comprises:

a gas discharge channel connected to said downstream end; and

a throttle valve disposed in said gas discharge channel.

### EFFECTS OF THE INVENTION

According to the first aspect of the present invention, a downstream part of a gas flow channel in which the concentration of a gas that is irrelevant to the reaction for electric power generation (referred to also as reaction-irrelevant gas, hereinafter), such as nitrogen and water vapor, is higher are adjacent to an upstream part of a gas flow channel in which the concentration of the reaction-irrelevant gas is lower, and therefore, gas diffusion to reduce the concentration gradient of the gas in the gas diffusion layer can be promoted. As a result, local accumulation of the reaction-irrelevant gas in the fuel cell can be prevented.

According to the second aspect of the present invention, a downstream end of the gas flow channel are adjacent to an upstream end of the gas flow channel, and therefore, gas diffusion to reduce the concentration gradient of the gas can be further promoted.

According to the third aspect of the present invention, first gas flow channels and second gas flow channels can be alternately disposed, and therefore, the number of the upstream parts and the downstream parts of the gas flow channels adjacent to each other is easily increased.

According to the fourth aspect of the present invention, upstream parts of gas flow channels and downstream parts of gas flow channels are alternately disposed, and therefore, smoothing of the distribution of the concentration of the gas irrelevant to the reaction for electric power generation can be more effectively promoted.

According to the fifth aspect of the present invention, the downstream part of a gas flow channel can be adjacent to the upstream part of the gas flow channel, and therefore, the number of gas distribution channels can be reduced.

According to the sixth aspect of the present invention, in a simple structure that does not need a special mechanism for discharging gas from the gas flow channels, local accumulation of the reaction-irrelevant gas in the fuel cell can be prevented.

According to the seventh aspect of the present invention, the gas flow channels can be purged as required. In addition, since local accumulation of the reaction-irrelevant gas in the fuel cell can be prevented, the frequency of purging can be reduced.

According to the eighth aspect of the present invention, in a fuel cell that discharges a reduced amount of gas to the gas discharge channel, local accumulation of the reaction-irrelevant gas in the fuel cell can be prevented.

### BRIEF DESCRIPTION OF DRAWINGS

FIG. 1 is a diagram for illustrating a configuration of a fuel cell according to an embodiment 1 of the present invention.

FIG. 2 is a diagram for illustrating a configuration of a fuel cell according to an embodiment 1 of the present invention.

FIG. 3 is a diagram for illustrating an effect of a reaction-irrelevant gas accumulation on the electric power generation of the fuel cell.

FIG. 4 is a diagram showing measurements of variations of partial pressures of hydrogen and nitrogen in the part of the anode in which the reaction-irrelevant gas is accumulated.

FIG. 5 is a diagram for illustrating an effect of the reaction-irrelevant gas accumulation on the electric power generation of the fuel cell.

FIG. 6 shows a configuration of a fuel cell prepared for comparison with the embodiment 1.

FIG. 7 shows measurements results of a fuel cell having the same configuration as the fuel cell according to the embodiment 1 and a fuel cell prepared for comparison with the embodiment 1.

FIG. 8 shows measurements results of the fuel cell according to the embodiment 1 and a fuel cell prepared for comparison with the embodiment 1.

FIG. 9 is a diagram for illustrating a configuration of modified example of the embodiment 1.

FIG. 10 is a diagram for illustrating a configuration of a fuel cell according to an embodiment 2 of the present invention.

FIG. 11 is a diagram for illustrating a configuration of a fuel cell according to an embodiment 3 of the present invention.

FIG. 12 is a diagram for illustrating a configuration of a fuel cell according to an embodiment 3 of the present invention.

FIG. 13 is a diagram for illustrating a configuration of a fuel cell according to an embodiment 4 of the present invention.

### DESCRIPTION OF NOTATIONS

| | |
|---|---|
| fuel cell | 10, 110, 210 |
| separator | 12, 112, 212, 312 |
| gas distribution channel | 14, 16, 114, 116, 214 |
| gas flow channel | 20, 22, 120, 122, 220, 320, 322 |
| electrolyte membrane | 30 |
| electrode catalyst layer | 32 |
| gas diffusion layer | 34 |
| gas discharge channel | 324 |
| purge valve | 354 |
| fuel cell stack | 350 |
| hydrogen tank | 356 |
| throttle valve | 454 |

### BEST MODE FOR CARRYING OUT THE INVENTION

### Embodiment 1

### [Configuration According to Embodiment 1]

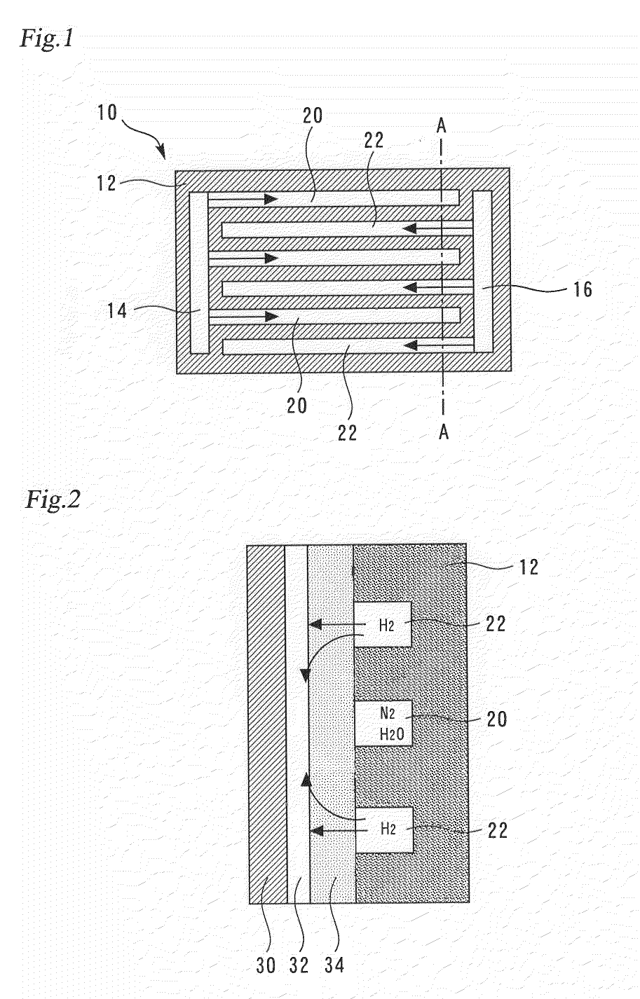

FIG. 1 is a diagram for illustrating a configuration of a fuel cell 10 according to an embodiment 1 of the present invention. The fuel cell 10 has a membrane electrode assembly, which has a stack of an electrolyte membrane and electrode catalyst layers on the opposite surfaces of the electrolyte membrane, at the center thereof. In addition, gas diffusion layers are stacked on the opposite surface of the membrane electrode assembly, and separators are stacked on the respective gas diffusion layers. The part on one side of the membrane electrode assembly serves as an anode, and the part on the other side of the membrane electrode assembly serves as cathode. FIG. 1 shows the fuel cell 10 viewed from the anode side, and a separator 12 of the anode is shown.

FIG. 1 shows a cross section of the separator 12 taken parallel to the plane of the separator 12. Therefore, gas distribution channels 14 and 16 and gas flow channels 20 and 22 formed in the separator 12 can be seen in FIG. 1. The gas distribution channels 14 and 16 are formed along the opposite short sides of the separator 12. The gas distribution channels 14 and 16 communicate with a fuel tank storing hydrogen (not shown).

The separator 12 has a plurality of gas flow channels 20 and 22 formed therein in parallel with each other. The gas flow channels 20 and 22 are substantially evenly alternately formed in the plane of the separator 12. The gas flow channels 20 extend for a portion of the length of the separator 12 from the gas distribution channel 14 and are completely closed at the respective tip ends. Similarly, the gas flow channels 22 extend for a portion of the length of the separator 12 from the gas distribution channel 16 and are completely closed at the respective tip ends.

The gas flow channels 20 and 22 extend in the opposite directions from the opposing two gas distribution channels 14 and 16 to form an interdigital configuration. The downstream ends of the gas flow channels 20 are adjacent to the upstream ends of the gas flow channels 22, and the upstream ends of the gas flow channels 20 are adjacent to the downstream ends of the gas flow channels 22.

Since the downstream ends of the gas flow channels 20 and 22 are closed, hydrogen supplied to the gas distribution channel 14 is distributed to each gas flow channel 20 and then accumulated in the gas flow channels 20. Similarly, hydrogen supplied to the gas flow channels 22 through the gas distribution channel 16 is accumulated in the gas flow channels 22.

FIG. 2 is a partially enlarged cross-sectional view of the fuel cell 10 taken along the line A-A in FIG. 1. FIG. 2 shows a stack structure on the anode side of the fuel cell 10. Specifically, FIG. 2 shows an electrolyte membrane 30, and an electrode catalyst layer 32, a gas diffusion layer 34 and the separator 12, which are components of the anode, in the fuel cell 10.

As shown in FIG. 2, the gas flow channels 20 and 22 in the separator 12 are adjacent to the gas diffusion layer 34. Therefore, in the fuel cell 10, gas flowing through the gas flow channels 20 and 22 is diffused into the gas diffusion layer 34 and eventually into the electrode catalyst layer 32.

Although not shown, the fuel cell 10 according to the embodiment 1 also has a cathode structure. As with the anode, the cathode has an electrode catalyst layer, a gas diffusion layer and a separator. The gas flow channels formed in the separator of the cathode are intended to distribute air, and the cathode is configured to supply air from the gas flow channels to the electrode catalyst layer through the gas diffusion layer. Known various cathode structures can be used, and therefore, detailed description of the structure of the cathode will be omitted.

### [Effect of Reaction-Irrelevant Gas Accumulation on Electric Power Generation]

The fuel cell generates electric power by an electrochemical reaction between hydrogen in the anode and oxygen in air in the cathode through the electrolyte membrane. For the fuel cell that generates electric power with hydrogen confined in the anode, hydrogen is continuously supplied in accordance with the hydrogen consumption in electric power generation. Therefore, during electric power generation, hydrogen continuously flows into the anode through a hydrogen supply port.

The electrolyte membrane is gas-permeable. Therefore, during electric power generation, while oxygen in the air in the cathode is consumed for electric power generation, gas that is irrelevant to the reaction for electric power generation (referred to as reaction-irrelevant gas hereinafter), such as nitrogen and water vapor, moves from the cathode to the anode through the electrolyte membrane.

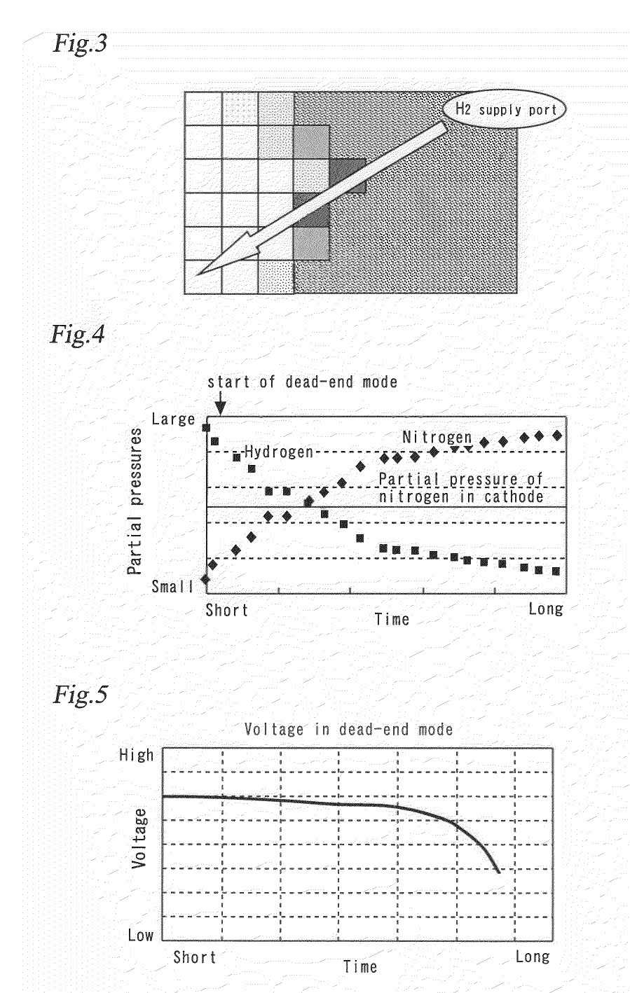

The reaction-irrelevant gas is carried to the downstream side of the anode by the flow of hydrogen into the anode. If the gas in the anode flows in a fixed direction, the local concentration of the reaction-irrelevant gas at the downstream position can increase (the reaction-irrelevant gas can be concentrated at the downstream position). In such a case, hydrogen and the reaction-irrelevant gas are nonuniformly distributed in the fuel cell. Next, the effect of such a nonuniform gas distribution on the electric power generation will be described with reference to FIGS. 3 to 5.

FIG. 3 is a diagram for illustrating an effect of a reaction-irrelevant gas accumulation described above on the electric power generation of the fuel cell. FIG. 3 shows a result of measurement of the current density distribution in a rectangular fuel cell sample during electric power generation. In the drawing, the color gradation represents the current density. Deeper colors represent higher current densities, and lighter colors represent lower current densities.

The fuel cell sample generates electric power using hydrogen continuously supplied to the anode at the upper right end thereof in the sheet of the drawing and confined in the anode. Therefore, in the sheet of FIG. 3, the upper right end corresponds to the upstream part of the gas flow in the fuel cell sample, and hydrogen flows from the upper right part to the lower left part (as indicated by the arrow in FIG. 3).

As described above, the reaction-irrelevant gas, such as nitrogen and water vapor, flows into the anode from the cathode through the electrolyte membrane. The reaction-irrelevant gas is carried by the hydrogen supplied to the anode. In the fuel cell sample shown in FIG. 3, since hydrogen flows from the upper right part to the lower left part in the sheet of the drawing, the reaction-irrelevant gas is carried toward the lower left part in the sheet of the drawing. As a result, the concentration of the reaction-irrelevant gas, or in other words, the partial pressure of the reaction-irrelevant gas with respect to the total pressure of the gas in the anode locally increases at the lower left part in the sheet of the drawing.

As a result, a reduced amount of hydrogen flows to that position, so that the amount of hydrogen in the anode decreases toward the lower left part (the downstream part) in the sheet of FIG. 3. Since the amount of electric power generation depends on the amount of hydrogen, the amount of electric power generation decreases in the downstream part.

FIG. 4 is a diagram showing measurements of variations of partial pressures of hydrogen and nitrogen in the part of the anode in which the reaction-irrelevant gas is accumulated (that is, the downstream end of the gas flow). Nitrogen and water vapor continuously move from the cathode to the anode when there is a difference in partial pressure of those gases between the electrodes. Therefore, the amount of nitrogen in the anode tends to increase with time.

The nitrogen having entered the anode is carried downstream by hydrogen and locally collected. When hydrogen is continuously supplied to compensate for the hydrogen consumption for electric power generation, the nitrogen having entered the anode is quickly collected in the downstream part, and therefore, the partial pressure of nitrogen in that part gradually increases.

As a result, as shown in FIG. 4, at the downstream end of the gas flow in the anode, the pressure of nitrogen largely increases with time, and the partial pressure of hydrogen decreases proportionately. Thus, in the fuel cell sample described above, the reaction-irrelevant gas is locally accumulated, and the amount (concentration) of the reaction-irrelevant gas concentrated at that position gradually increases.

FIG. 5 is a diagram showing a result of measurement of the time-varying voltage of the fuel cell sample used in the measurement shown in FIGS. 3 and 4. As the reaction-irrelevant gas is concentrated as described with reference to FIG. 4, the amount of hydrogen supplied to the part at which the reaction-irrelevant gas is concentrated decreases, and the nonuniformity of the amount of electric power generation described with reference to FIG. 3 becomes more remarkable. This has an effect on the electric power generation of the entire fuel cell, and the voltage of the fuel cell decreases with time as shown in FIG. 5. As a result, the fuel cell cannot efficiently generate electric power.

### [Characteristics and Effects of Embodiment 1]

To address the problems described above, according to the embodiment 1, the downstream ends of the gas flow channels 20 and the upstream ends of the gas flow channels 22 are adjacent to each other, and the upstream ends of the gas flow channels 20 and the downstream ends of the gas flow channels 22 are adjacent to each other.

As described above, during electric power generation of the fuel cell 10, hydrogen flows into the gas flow channels 20 and 22 through the gas distribution channels 14 and 16. The reaction-irrelevant gas in the anode is carried to the downstream parts of the gas flow channels 20 and 22 by the hydrogen flow through the gas flow channels 20 and 22. As a result, the concentration of the reaction-irrelevant gas in the downstream parts of the gas flow channels 20 and 22 relatively increases. In particular, the concentration of the reaction-irrelevant gas is maximized at the downstream end of the gas flow channels 20 and 22.

To the contrary, the concentration of the reaction-irrelevant gas relatively decreases at the upstream parts of the gas flow channels 20 and 22 (in other words, the hydrogen concentration relatively increases in the gas flow channels). In particular, the concentration of the reaction-irrelevant gas is minimized at the upstream end of the gas flow channels 20 and 22 (in other words, the hydrogen concentration is maximized at the upstream end of the gas flow channels).

As shown in FIG. 2, the gas flow channels 20 and 22 are adjacent to the gas diffusion layer 34. Therefore, the gas in the gas flow channels 20 and 22 is diffused into the gas diffusion layer 34. Thus, a larger amount (a higher concentration) of reaction-irrelevant gas is supplied to a part of the gas diffusion layer 34 that is adjacent to the downstream parts of the gas flow channels 20 and 22. On the other hand, a larger amount of hydrogen is supplied to a part of the gas diffusion layer 34 that is adjacent to the upstream parts of the gas flow channels 20 and 22.

Since the upstream parts and the downstream parts of the gas flow channels 20 and 22 are adjacent to each other, parts containing a higher concentration of reaction-irrelevant gas and parts containing a higher concentration of hydrogen are adjacent to each other in the gas diffusion layer 34. Thus, gas diffusion occurs in the gas diffusion layer 34 to reduce the concentration gradient of the reaction-irrelevant gas and hydrogen.

Specifically, as shown by the arrows in FIG. 2, hydrogen diffuses in the gas diffusion layer 34 because of the concentration gradient thereof from parts adjacent to the upstream parts of the gas flow channels 22 in which the partial pressure of hydrogen is higher to parts adjacent to the downstream parts of the gas flow channels 20 in which the partial pressure of the reaction-irrelevant gas (only nitrogen and water vapor are shown in FIG. 2) is higher. Similarly, although not shown, the reaction-irrelevant gas diffuses in the gas diffusion layer 34 to reduce the concentration difference thereof.

As such gas diffusion proceeds, the gas distribution in the gas diffusion layer 34 becomes more uniform, and eventually, hydrogen is substantially uniformly distributed in the fuel cell 10. Therefore, the decrease in voltage of the generated electric power due to local accumulation of the reaction-irrelevant gas can be reduced.

As described above, in the fuel cell 10 according to the embodiment 1, the downstream parts of the gas flow channels 20 and 22 are adjacent to the upstream parts of the gas flow channels 22 and 20, respectively, and therefore, gas diffusion to reduce the concentration gradient of the reaction-irrelevant gas is promoted. As a result, local accumulation of the gas that is not irrelevant to the reaction occurring in the fuel cell is prevented with a simple configuration.

In particular, according to the embodiment 1, the downstream ends of the gas flow channels 20 and 22 at which the concentration of the reaction-irrelevant gas is maximized and the upstream ends of the gas flow channels 22 and 20 at which the concentration of the reaction-irrelevant gas is minimized are adjacent to each other, respectively. This also effectively promotes the gas diffusion to reduce the concentration gradient of the reaction-irrelevant gas, and the concentration gradient of the reaction-irrelevant gas is reduced more quickly.

In addition, according to the embodiment 1, the gas distribution channels 14 and 16 serving as hydrogen supply ports are positioned to oppose each other with the gas diffusion layer 34 interposed therebetween. The gas flow channels 20 and 22 extend from the opposing gas distribution channels. With such a configuration, each gas flow channel can be relatively short. The longer the gas flow channel, the larger amount of reaction-irrelevant gas is carried toward the downstream end of the gas flow channel. However, according to the embodiment 1, the gas flow channels are shortened, thereby reducing the total amount of reaction-irrelevant gas carried toward the downstream end of the gas flow channels.

In addition, since the gas distribution channels 14 and 16 are disposed to oppose each other, the gas flow channels 20 and 22 can be alternately disposed. Therefore, the number of upstream parts and downstream parts of the gas flow channels that are adjacent to each other can be easily increased. Therefore, reduction of the concentration gradient of the reaction-irrelevant gas can be more easily promoted.

In addition, according to the embodiment 1, the gas flow channels 20 and 22 are substantially evenly alternately disposed. With such a configuration, since the upstream ends and the downstream ends of the gas flow channels 20 and 22 are evenly alternately disposed, reduction of the concentration gradient of the reaction-irrelevant gas can be more effectively promoted.

In addition, in the fuel cell 10 according to the embodiment 1, since the downstream ends of the gas flow channels 20 and 22 are completely closed, purging cannot be conducted. However, according to the embodiment 1, the downstream ends and the upstream ends of the gas flow channels are adjacent to each other, so that gas diffusion to reduce the concentration gradient of the reaction-irrelevant gas is promoted. Therefore, the embodiment 1 has an advantage provided by the absence of a mechanism for purging (for example, complication of the structure is avoided), while preventing local accumulation of the reaction-irrelevant gas.

In the embodiment 1, the downstream ends of the gas flow channels 20 and 22 and the upstream ends of the gas flow channels 22 and 20 are adjacent to each other, respectively. However, the present invention is not limited to this arrangement. Even if the upstream ends and the downstream ends of the gas flow channels are not adjacent to each other, gas diffusion to reduce the gas concentration gradient can be promoted if downstream parts of the gas flow channels 20 and 22 and upstream parts of the gas flow channels 22 and 20 are adjacent to each other, respectively.

That is, in the present invention, the downstream part of the gas flow channel can be referred to also as a part of the gas flow channel in which the concentration of the reaction-irrelevant gas is relatively high. Similarly, the upstream part of the gas flow channel can be referred to also as a part of the gas flow channel in which the concentration of the reaction-irrelevant gas is relatively low. If parts that differ in concentration of the reaction-irrelevant gas are adjacent to each other, the gas diffusion described above occurs, and as a result, local accumulation of the reaction-irrelevant gas can be prevented as in the embodiment 1.

If the downstream end of a gas flow channel, which is the part at which the concentration of the reaction-irrelevant gas is maximized, and the upstream end of a gas flow channel, which is the part at which the concentration of the reaction-irrelevant gas is minimized, are adjacent to each other, the gas diffusion is more significantly promoted, and the local accumulation of the reaction-irrelevant gas is more effectively prevented.

For example, in the interdigital configuration of the gas flow channels shown in FIG. 1, the gas flow channels can interdigitate over a shorter length than in FIG. 1. In such a case, the local accumulation of the gas that is not irrelevant to the reaction can be prevented with a simple configuration.

The description in the embodiment 1 that the upstream ends and the downstream ends of the gas flow channels are adjacent to each other can also be described as the upstream parts and the downstream parts of the gas flow channels being disposed to be adjacent to each other in the direction of the plane of the gas diffusion layer. For example, in a fuel cell stack composed of a plurality of fuel cells according to this embodiment, the gas flow channels 20 and 22 of each fuel cell can be adjacent to each other in the direction of stacking. However, the description that the gas flow channels are adjacent to each other in the present invention means that the gas flow channels are adjacent to each other not in the direction of stacking but in the direction of the plane of the gas diffusion layer.

In addition, in the embodiment 1, hydrogen is distributed to the gas flow channels 20 through the gas distribution channel 14 and to the gas flow channels 22 through the gas distribution channel 16. However, the primary function of the gas distribution channels 14 and 16 is to supply hydrogen to the gas flow channels 20 and 22, and the function of distributing hydrogen at the respective positions is a secondary function in the configuration according to the embodiment 1. Therefore, in the case where each gas distribution channel communicate with only one gas flow channel, the “gas distribution channel” functions simply as a “gas supply channel”.

The stack structure of the electrolyte membrane 30 and the electrode catalyst layers 32 in the embodiment 1 described above corresponds to the “membrane electrode assembly” in the first aspect of the present invention described earlier, the gas diffusion layer 34 in the embodiment 1 corresponds to the “gas diffusion layer” in the first aspect of the present invention, the gas distribution channels 14 and 16 in the embodiment 1 correspond to the “gas supply channel” in the first aspect of the present invention, and the gas flow channels 20 and 22 in the embodiment 1 correspond to the “gas flow channels” in the first aspect of the present invention.

In addition, the gas distribution channels 14 and 16 in the embodiment 1 described above correspond to the “first gas distribution channel” and the “second gas distribution channel” in the third aspect of the present invention, respectively, and the gas flow channels 20 and 22 in the embodiment 1 correspond to the “first gas flow channel” and the “second gas flow channel” in the third aspect of the present invention, respectively.

In addition, the state in which the gas flow channels 20 and 22 are substantially evenly alternately arranged in the vertical direction in the sheet of the drawing in the embodiment 1 described above corresponds to the state in which the first gas flow channel and the second gas flow channel are substantially evenly alternately disposed in the fourth aspect of the present invention.

In addition, the state in which the gas flow channel 20 extends for a portion of the length of the separator 12 from the gas distribution channel 14 and is completely closed at the downstream end thereof in the embodiment 1 described above corresponds to the state in which the gas flow channel is completely closed at the downstream end thereof in the sixth aspect of the present invention.

### [Result of Experiment on Fuel Cell According to Embodiment 1]

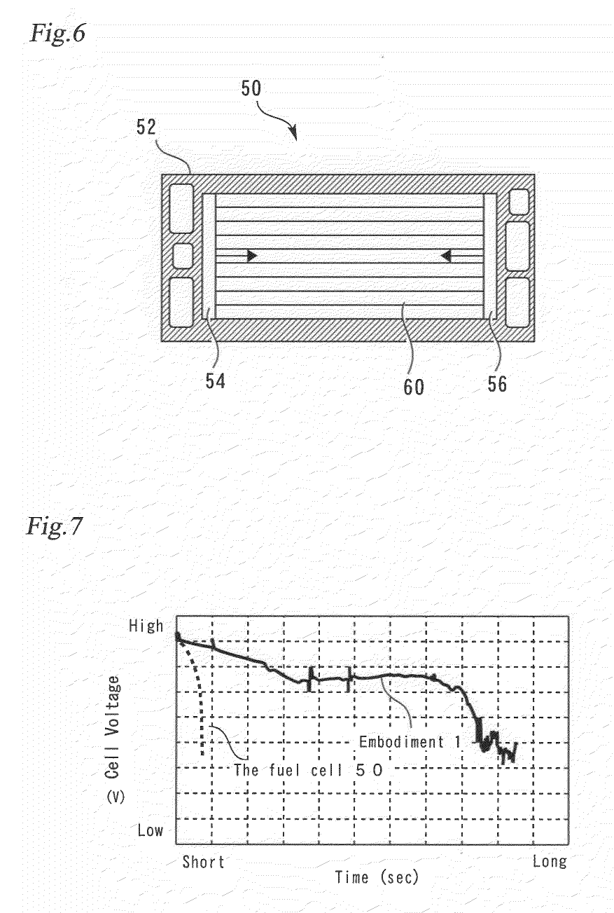

In the following, with reference to FIGS. 6 to 8, the result of an experiment on the effect of preventing accumulation of the reaction-irrelevant gas in the fuel cell 10 according to the embodiment 1 will be described. In this experiment, for comparison, the time change of the voltage is examined for a fuel cell having the configuration according to the embodiment 1 and fuel cells having other configurations. The voltage of the fuel cell samples having different configurations is measured while the fuel cells generate electric power with hydrogen confined in the anode.

FIG. 6 shows a configuration of a fuel cell prepared for comparison with the embodiment 1. FIG. 6 is a cross-sectional view of an anode side of a fuel cell 50 taken parallel to the plane of the separator of the anode as in the embodiment 1.

A separator 52 has gas distribution channels 54 and 56, which correspond to the gas distribution channels 14 and 16 in the embodiment 1. The separator 52 has gas flow channels 60 extending in the horizontal direction in the sheet of the drawing formed in a middle part thereof. The gas flow channels 60 are formed by press working of the separator 52. Unlike the gas flow channels 20 and 22 in the embodiment 1, each gas flow channel 60 communicates with both the gas distribution channels 54 and 56. In this example, three fuel cells 50 that differ in depth of the gas flow channels 60 (a sample having gas flow channels 60 having a depth of 0.2 mm, a sample having gas flow channels 60 having a depth of 0.5 mm, and a sample having gas flow channels 60 having an intermediate depth between 0.2 mm and 0.5 mm) are prepared.

When the voltage of the fuel cell 50 is measured, hydrogen is externally supplied to the gas distribution channels 54 and 56. The hydrogen flows in the direction of the arrows in FIG. 6, and reaction-irrelevant gas in the anode is carried by the hydrogen toward the center part in the sheet of the drawing. The fuel cell 50 does not have the mechanism for preventing accumulation of the reaction-irrelevant gas described in the embodiment 1. Therefore, during electric power generation, the reaction-irrelevant gas is locally accumulated in the center part of the fuel cell 50 in the sheet of the drawing.

FIG. 7 shows measurements of the time-varying voltage of a fuel cell having the same configuration as the fuel cell 10 according to the embodiment 1 and the fuel cell 50 having gas flow channels 60 having a depth of 0.2 mm. In FIG. 7, the solid line indicates measurements for the fuel cell having the same configuration as the fuel cell 10, and the dotted line indicates measurements for the fuel cell 50. Compared with the voltage indicated by the dotted line, the voltage of electric power generation indicated by the solid line gently decreases. Thus, it can be determined that the configuration of the fuel cell 10 prevents local accumulation of the reaction-irrelevant gas and reduces the effect of the reaction-irrelevant gas on the electric power generation.

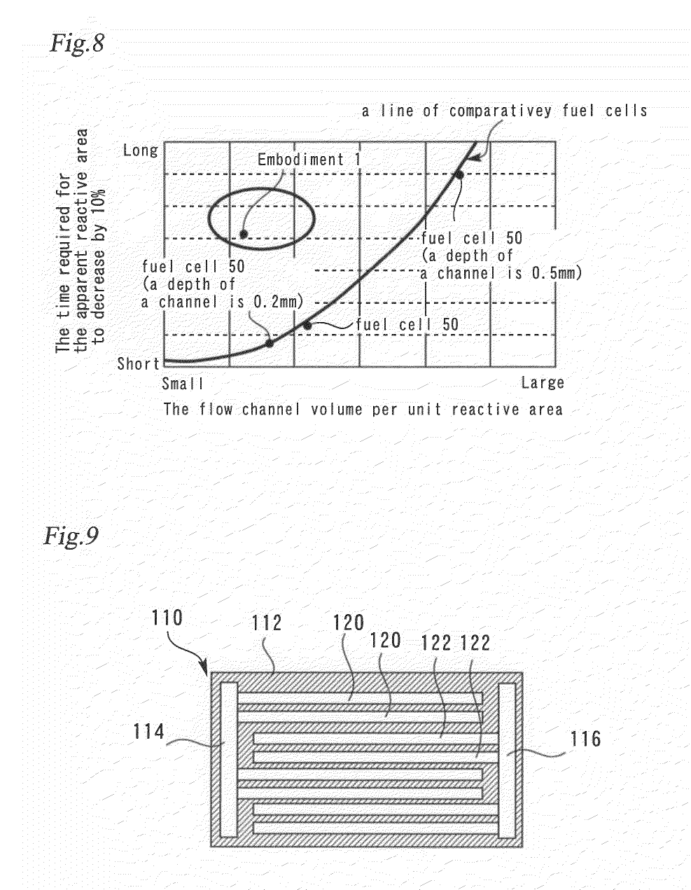

FIG. 8 shows a summary of the measurements shown in FIG. 7. For the fuel cell 50 shown in FIG. 6, a summary of measurements of all of the three samples different in depth of the gas flow channels 60 is shown. In the graph of FIG. 8, the abscissa indicates the flow channel volume per unit reactive area of the fuel cell, and the ordinate indicates the time required for the apparent reactive area to decrease by 10%.

Based on a common reference for the gas flow channel volume per unit reactive area of the fuel cell, that is, the ease of increase of the concentration of the reaction-irrelevant gas, and by converting the voltage drop of the fuel cell to the decrease of the electric power generation area, the samples are compared.

As shown in FIG. 8, for the same flow channel volume, the time for the apparent electric power generation area to decrease by 10% is longer in the fuel cell having the configuration according to the embodiment 1. From this fact, it can be determined that the configuration of the fuel cell according to the embodiment 1 promotes the gas diffusion to reduce the concentration gradient of the reaction-irrelevant gas and prevents local concentration of the reaction-irrelevant gas.

### [Modification of Embodiment 1]

### (First Modification)

In the embodiment 1, the gas flow channels 20 and 22 are substantially evenly alternately disposed in such a manner that each gas flow channel 20 (or 22) interdigitates with each gas flow channel 22 (or 20). However, the present invention is not limited to this arrangement. The gas flow channels 20 and 22 can be disposed in such a manner that pairs of gas flow channels 20 (or 22) interdigitate with pairs of gas flow channels 22 (or 20).

Specifically, a fuel cell 110 configured as shown in FIG. 9 is possible. A separator 112 of the fuel cell 110 has gas distribution channels 114 and 116, gas flow channels 120 communicating with the gas distribution channel 114, and gas flow channels 122 communicating with the gas distribution channel 116. Pairs of gas flow channels 120 and pairs of gas flow channels 122 are substantially evenly alternately disposed.

Even with such a configuration, downstream parts of the gas flow channels 120 and upstream parts of the gas flow channels 122 are adjacent to each other, and therefore, local accumulation of the reaction-irrelevant gas can be prevented as in the embodiment 1. The fuel cell shown in FIG. 9 can be described as having groups of gas flow channels that are substantially evenly alternately disposed.

As an alternative to the configurations of the fuel cell 10 according to the embodiment 1 and the fuel cell 110 shown in FIG. 9, the gas flow channels 20 and 22 alternately disposed can be unevenly disposed. Specifically, different numbers of gas flow channels 20 and 22 can be alternately disposed. For example, the gas flow channels 20 and 22 can be arranged in such a manner that one gas flow channel 22 is adjacent to two gas flow channels 20, two gas flow channels 20 are adjacent to the one gas flow channel 22, one gas flow channel 22 is adjacent to the two gas flow channels 20, and so on.

As an alternative to the configurations described above, the gas flow channels 20 and 22 can be alternately but irregularly disposed. Specifically, for example, the gas flow channels 20 and 22 can be irregularly arranged in such a manner that one gas flow channel 22 is adjacent to three gas flow channels 20, two gas flow channels 20 are adjacent to the one gas flow channel 22, three gas flow channels 22 are adjacent to the two gas flow channel 20, and so on. Even if the gas flow channels are not substantially evenly disposed, the upstream parts and the downstream parts of one group of gas flow channels are adjacent to the downstream parts and the upstream parts of the other group of gas flow channels, respectively, as far as the gas flow channels are alternately disposed. Therefore, smoothing of the concentration distribution of the gas that is irrelevant to the reaction for electric power generation can be effectively promoted.

In the configuration according to the embodiment 1 described above, the gas flow channels are configured to be bilaterally symmetrical in the sheet of the drawing. However, the present invention is not limited to this configuration. The gas flow channels can be asymmetrically configured. It is essential only that the upstream part and the downstream part of the gas flow channel(s) are adjacent.

### Embodiment 2

### [Configuration, Characteristics and Effects of Embodiment 2]

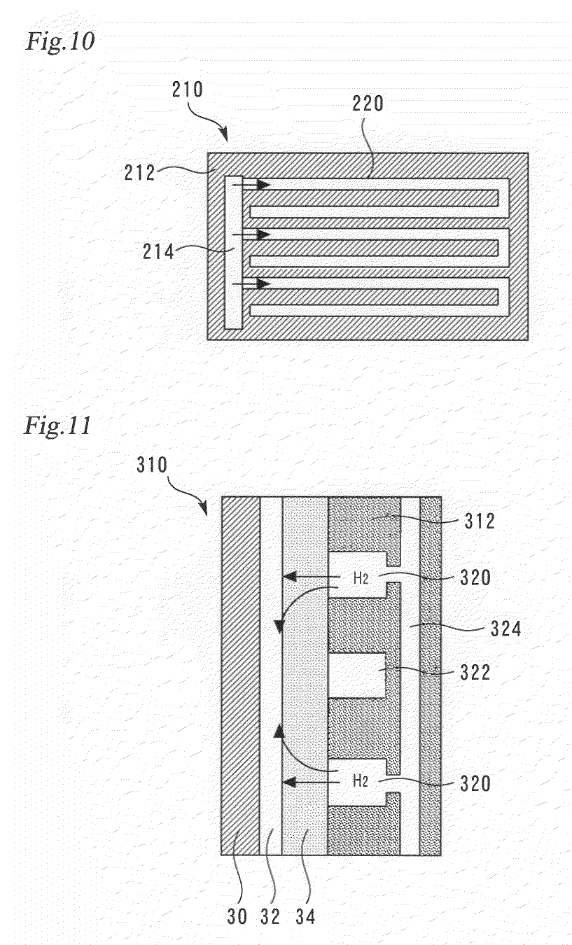

FIG. 10 is a diagram for illustrating a configuration of a fuel cell 210 according to an embodiment 2 of the present invention, which corresponds to FIG. 1 illustrating the embodiment 1. FIG. 10 shows the fuel cell 210 viewed from the anode side, and a separator 212 of the anode is shown. The fuel cell according to the embodiment 2 has an electrolyte membrane, electrode catalysts and gas diffusion layers as in the embodiment 1.

In the embodiment 1, two gas distribution channels, specifically, the gas distribution channels 14 and 16, are disposed at the opposite ends of the separator 12. However, according to the embodiment 2, as shown in FIG. 10, the separator 212 has only one gas distribution channel.

In the fuel cell 210 according to the embodiment 2, three gas flow channels 220 communicate with one gas distribution channel 214. The gas flow channels 220 extend in one direction from the gas distribution channel 214 and are folded back halfway. The gas flow channels 220 further extend from the folded parts so that the downstream ends thereof are disposed close to the gas distribution channel 214, that is, the upstream ends thereof.

Gas flowing into the gas flow channels through the gas distribution channel 214 flows to the closed downstream ends through the folded parts, so that hydrogen is accumulated in the gas flow channels 220. With such a configuration, since the downstream parts and the upstream parts of the gas flow channels 220 are adjacent to each other, local accumulation of the reaction-irrelevant gas can be prevented as in the embodiment 1.

In addition, according to the embodiment 2, the upstream part and the downstream part of each gas flow channel are adjacent to each other. As a result, compared with the case where two gas distribution channels are disposed to oppose each other and gas flow channels are alternately disposed as in the embodiment 1, the number of gas distribution channels can be reduced. As a result, for example, the space on the separator 212 can be efficiently used. In addition, there is no need to form a large number of through holes in the separator 212, and therefore, problems, such as reduction in strength of the separator 212, can be avoided.

The shape of the folded part of the gas flow channel is not limited to the U shape shown in FIG. 10, other various shapes, such as W shape, are possible. The folded part of the gas flow channel 220 in the embodiment 2 described above corresponds to the “folded part” in the fifth aspect of the present invention described earlier.

### Embodiment 3

### [Configuration of Fuel Cell According to Embodiment 3]

FIG. 11 is a diagram for illustrating a fuel cell 310 according to an embodiment 3 of the present invention. FIG. 11 is a partially enlarged cross-sectional view of a part of the fuel cell 310 corresponding to the part of the fuel cell 10 according to the embodiment 1 shown in FIG. 2 (taken along the line A-A in FIG. 1). The fuel cell 310 has substantially the same configuration as the fuel cell 10. However, the structure of a separator 312 attached to the gas diffusion layer 34 differs from the structure of the separator 12 of the fuel cell 10.

Gas flow channels 320 and 332 in the separator 312 have the same configuration as the gas flow channels 20 and 22 in the embodiment 1. Specifically, as with the gas flow channels 20 and 22 described above with reference to FIG. 1, the gas flow channels 320 and 322 interdigitally extend in the plane of the separator 312. The downstream ends of the gas flow channels 320 and the upstream ends of the gas flow channels 322 are adjacent to each other, and the upstream ends of the gas flow channels 320 and the downstream ends of the gas flow channels 322 are adjacent to each other (see FIG. 1).

The part shown in FIG. 11 corresponds to the part of the fuel cell 10 according to the embodiment 1 shown in FIG. 2. That is, as with FIG. 2 showing a downstream part of a gas flow channel 20 and upstream parts of gas flow channels 22 adjacent to each other, FIG. 11 shows downstream parts of gas flow channels 320 and an upstream part of a gas flow channel 322 adjacent to each other.

Unlike the separator 12 in the embodiment 1, the separator 312 has a gas discharge channel 324 formed therein. The gas discharge channel 324 locally communicates with the downstream end of each gas flow channel 320. The gas discharge channel 324 does not communicate with the gas flow channels 322. With such a configuration, the gas in the gas flow channels 320 flowing to the downstream parts of the gas flow channels 320 flows into the gas discharge channel 324 through the downstream parts thereof.

Although not shown, the separator 312 also has a second gas discharge channel locally communicating with the downstream parts of the gas flow channels 322. The second gas discharge channel is formed in the separator 312 in such a manner that the second gas discharge channel does not interfere with the gas discharge channel 324. As with the gas discharge channel 324, gas flows into the second gas discharge channel through the downstream parts of the gas flow channels 322.

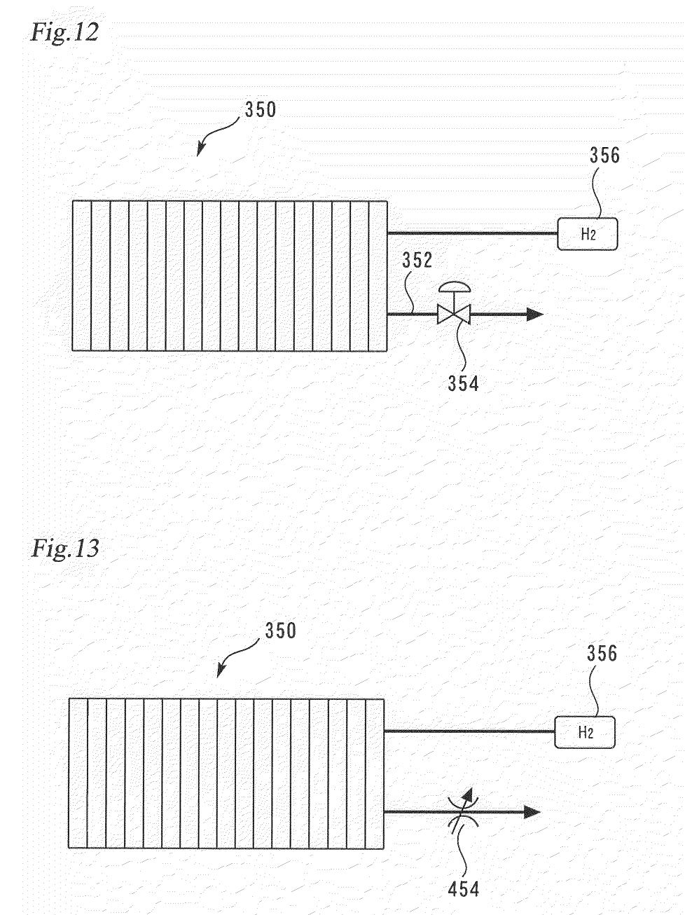

FIG. 12 shows a fuel cell system having the fuel cell according to the embodiment 3. FIG. 11 shows a fuel cell stack 350 composed of a plurality of fuel cells according to the embodiment 3. The gas discharge channels (the gas discharge channels 324 and the second gas discharge channels, not shown) of the fuel cells 310 in the fuel cell stack 350 are collectively connected to a pipe 352 outside of the stack.

The pipe 352 is connected to a purge valve 354. When the purge valve 354 is opened, the pipe 352 communicates with a gas discharge system (not shown) located downstream thereof. When the purge valve 354 is closed, the gas flow is blocked by the purge valve 354, and the gas is accumulated in the fuel cells 310.

The fuel cell stack 350 communicates with a hydrogen tank 356. The hydrogen tank 356 communicates with the gas distribution channel (not shown) of each fuel cell 310 in the fuel cell stack 350 via a hydrogen supply valve (not shown). With such a configuration, hydrogen is appropriately supplied from the hydrogen tank 356 to the gas distribution channels of the fuel cells 310 and then flows into the gas flow channels 320 and 322.

### [Characteristics and Effects of Embodiment 3]

When the fuel cells according to the embodiment 3 generate electric power, the purge valve 354 is closed, and hydrogen is supplied from the hydrogen tank 356. In this way, as in the embodiment 1, the fuel cells 310 generate electric power with hydrogen accumulated in the respective gas flow channels 320 and 322. As with the fuel cell 10 according to the embodiment 1, in the fuel cell 310, the upstream ends of the gas flow channels 320 and the downstream ends of the gas flow channels 322 are adjacent to each other. Therefore, the fuel cell 310 also prevents local accumulation of the reaction-irrelevant gas.

According to the embodiment 3, when the concentration of the reaction-irrelevant gas in the fuel cells 310 reaches a predetermined value during continuous electric power generation, the purge valve 354 is opened. Then, the gas in the gas flow channels 320 is discharged through the gas discharge channels 324 to the gas discharge system. With such a configuration, the gas flow channels 320 and 322 can be purged as required by appropriately opening the purge valve 354.

As described above, according to the embodiment 3, the gas flow channels can be purged as required. In addition, since local accumulation of the gas that is irrelevant to the reaction in the fuel cell 310 can be prevented, the frequency of purging can be reduced.

In the embodiment 3, the fuel cell stack 350 composed of a plurality of fuel cells 310 has been described. However, the present invention is not limited to this arrangement. For example, the gas discharge channel 324 of only one fuel cell 310 can be connected to the purge valve 354. The concept of the present invention can be applied to any types of fuel cells that have a gas discharge channel that is connected to a purge valve and purged appropriately. Furthermore, a mechanism other than the purge valve 354 can be used to open and close the communication of the gas discharge channel 324 with the outside to appropriately purge the gas discharge channel 324.

The gas discharge channel 324 in the embodiment 3 described above corresponds to the “gas discharge channel” in the seventh aspect of the present invention described earlier, the purge valve 354 corresponds to the “purge valve” in the seventh aspect of the present invention, and the gas flow channels 320 and 322 correspond to the “gas flow channels” in the seventh aspect of the present invention.

### Embodiment 4

### [Configuration of Embodiment 4]

FIG. 13 is a diagram for illustrating an embodiment 4 of the present invention. The embodiment 4 is substantially the same in configuration as the embodiment 3. However, the embodiment 4 differs from the embodiment 3 in that the gas discharge channel 324 communicate with the gas discharge system via a throttle valve 454 instead of the purge valve 354. The same components as those in the embodiment 3 are denoted by the same reference numerals, and descriptions thereof will be omitted.

### [Characteristics and Effects of Embodiment 4]

When the fuel cell according to the embodiment 4 generates electric power, hydrogen is appropriately supplied from the hydrogen tank 356 as in the embodiment 3. The opening of the throttle valve 454 is adjusted to reduce the gas flow at that location, and in this state, gas is discharged to the gas discharge system (not shown) (such gas discharge is referred to also as small discharge). During small discharge, reaction-irrelevant gas is continuously discharged to the gas discharge system, and an increase of the reaction-irrelevant gas in the fuel cell 310 is prevented.

However, for example, if a large amount of reaction-irrelevant gas moves from the cathode to the anode, the concentration of the reaction-irrelevant gas in the anode can gradually increase. In such a case, the reaction-irrelevant gas remains in the gas flow channels, and the reaction-irrelevant gas can be locally accumulated in the downstream parts of the gas flow channels.

To address the problem, according to the embodiment 4, the fuel cells 310 in the fuel cell stack 350 are configured to prevent local accumulation of the reaction-irrelevant gas. Therefore, even if the reaction-irrelevant gas in the gas flow channels increases, local accumulation of the gas in the fuel cells can be prevented. In other words, the embodiment 4 can cover the shortcoming of a structure only capable of small discharge operation.

As described above, the configuration according to the embodiment 4 can prevent an increase of the reaction-irrelevant gas in the anode by small discharge and promote the gas diffusion to reduce the concentration gradient of the reaction-irrelevant gas. As a result, an increase of the concentration (amount) of the reaction-irrelevant gas in the fuel cell 310 can be prevented, and local accumulation of the reaction-irrelevant gas in the fuel cell 310 can also be prevented.

In the embodiment 4, the throttle valve 454 is used to achieve small discharge. However, the present invention is not limited to the use of the throttle valve 454. Various gas flow rate adjusting mechanism other than the throttle valve 454 can be used to achieve small discharge. Furthermore, small discharge can be achieved simply by appropriately setting the diameter of the gas outlet port at a predetermined dimension, rather than adjusting the gas flow rate.

The gas discharge channel (not shown) in the embodiment 4 described above corresponds to the “gas discharge channel” in the eighth aspect of the present invention described earlier, and the throttle valve 454 corresponds to the “throttle valve” in the eighth aspect of the present invention.

As described above, the present invention can be applied to a fuel cell that has a gas flow channel substantially closed at the downstream end thereof. The phrase “substantially closed” does not mean that no gas flow occurs. Specifically, the “structure substantially closed” can be referred to also as the “structure in which the concentration (partial pressure) of the reaction-irrelevant gas is higher in the downstream part of the gas flow channel”.

Therefore, the phrase “the structure substantially closed” used in the present invention includes the structures shown in the embodiments 1 to 4. The fuel cells that have the gas flow channels closed at the downstream ends described above in the embodiments 1 to 4 can be referred to also as dead-end-type fuel cell or non-circulation-type fuel cell.

In the embodiments 1 to 4 and the modifications thereof described above, fuel cells having a plurality of gas flow channels have been described. However, the present invention is not limited to those fuel cells. Even for a fuel cell having only one gas flow channel, as in the embodiment 1, the gas diffusion to reduce the gas concentration gradient in the gas diffusion layer 34 can be promoted by forming the gas flow channel so that the upstream part thereof and the downstream part thereof are adjacent to each other. Thus, local accumulation of the reaction-irrelevant gas can be prevented.

The fuel cells according to the embodiments described above have the following advantages over the technique disclosed in the Japanese Patent Laid-Open No. 2005-116205 described earlier. The fuel cell disclosed in the Japanese Patent Laid-Open No. 2005-116205 described earlier has a plurality of gas supply ports and a plurality of valves connected to the respective gas supply ports and makes the gas distribution in the fuel cell uniform by opening and closing each valve, and therefore, the configuration can be complicated.

However, the fuel cells according to the embodiments described above can prevent local accumulation of the reaction-irrelevant gas with a relatively simple configuration because of the specially constructed gas flow channels in the separators. In addition, according to the embodiments described above, the nonuniformity of the gas concentration in the plane direction in the fuel cell can be effectively reduced.

A fuel cell that generates electric power that meets at least one of the following conditions (i) to (iii) is included among dead-end-type fuel cells.

(i) A fuel cell that continuously generates electric power without discharging gas from the anode (the gas flow channels on the anode side).

(ii) A fuel cell that continuously generates electric power in a state where the partial pressure of an impurity gas in the anode (the reaction-irrelevant gas, such as nitrogen, having moved to the anode from the cathode through the electrolyte membrane in the embodiments described above) and the partial pressure of the impurity gas in the cathode substantially balance with each other (or are substantially equal to each other). In other words, a fuel cell that generates electric power in a state where the partial pressure of the impurity gas in the anode is raised to the partial pressure of the impurity gas in the cathode.

As described in the embodiment 1, the electrolyte membrane is gas-permeable. If there is a difference in partial pressure of a gas between the cathode and the anode, the gas moves through the electrolyte membrane to reduce the partial pressure difference. As a result, the partial pressure of the impurity gas in the anode and the partial pressure of the impurity gas in the cathode eventually substantially balance with each other. The fuel cell (ii) is a fuel cell that generates electric power in such a state.

(iii) A fuel cell that substantially completely consumes the fuel supplied to the anode (the reactive gas containing hydrogen in the embodiments described above) in generating electric power.

The phrase “substantially completely” preferably means the whole of the supplied fuel excluding the fuel that leaks to the outside of the anode through the sealing structure and the electrolyte membrane.

The configuration of the fuel cell according to the present invention can be applied to a fuel cell that does not always operate in the dead-end mode but operates in the dead-end mode in particular circumstances (when the load is small, for example). That is, the application of the present invention is not limited to the fuel cells that operate in the dead-end mode under all the electric power generation conditions. The concept of the present invention can be applied to any fuel cell that operates in the dead-end mode under a certain electric power generation condition (when the load is small, for example).

In the fuel cells according to the present invention, the gas flow channels on the cathode side can have the same configuration as the gas flow channels on the anode side. However, the gas flow channels on the cathode side can have a configuration different from that of the gas flow channels on the anode side in terms of reducing the pressure loss, for example.

For example, in terms of reducing the pressure loss, the gas flow channels on the cathode side preferably communicate with both the supply port and the discharge port for the cathode gas (air in the embodiments described above). That is, when a fuel cell stack is formed by the fuel cells according to the present invention, the gas flow channels on the cathode side of each fuel cell preferably communicate with both the gas supply manifold and the gas discharge manifold on the cathode side.

The gas flow channels on the cathode side are preferably groove flow channels, dimple flow channels or porous flow channels (a porous material used as a structure for passing gas). Gas supply and discharge through the gas flow channels on the cathode side can be facilitated by configuring the gas flow channels on the cathode side so that the pressure loss in the gas flow channels on the cathode side is lower than that in the gas flow channels on the anode side or the pressure loss is constant.

1. A fuel cell comprising:
a membrane electrode assembly;
a gas diffusion layer stacked on said membrane electrode assembly;
one or more gas flow channels formed adjacent to said gas diffusion layer; and
a gas supply channel through which gas supplied to said gas flow channels flows, said gas flow channels communicating with said gas supply channel at the upstream ends thereof and being substantially closed at downstream ends thereof,
wherein a downstream part of a gas flow channel of said gas flow channels is adjacent to an upstream part of the gas flow channel or an upstream part of another gas flow channel of said gas flow channels.

2. The fuel cell according to claim 1, wherein the downstream end of a gas flow channel of said gas flow channels is adjacent to the upstream end of the gas flow channel or the upstream end of another gas flow channel of said gas flow channels.

3. The fuel cell according to claim 1, wherein said gas supply channel includes a first gas supply channel and a second gas supply channel that are disposed with said gas diffusion layer interposed therebetween in the direction of the plane of said membrane electrode assembly,
said gas flow channels include a first gas flow channel that communicates with said first gas supply channel at the upstream end thereof and is substantially closed at the downstream end thereof and a second gas flow channel that communicates with said second gas supply channel at the upstream end thereof and is substantially closed at the downstream end thereof, and
an upstream part of said first gas flow channel and a downstream part of said second gas flow channel are adjacent to each other, and a downstream part of the first gas flow channel and an upstream part of the second gas flow channel are adjacent to each other.

4. The fuel cell according to claim 3, wherein said first gas flow channel and said second gas flow channel are disposed alternately.

5. The fuel cell according to claim 1, wherein said gas flow channel has a folded part between said upstream part and said downstream part, and
the downstream part of the gas flow channel is adjacent to the upstream part of the gas flow channel.

6. The fuel cell according to claim 1, wherein said gas flow channel is completely closed at the downstream end thereof.

7. The fuel cell according to claim 1, wherein the fuel cell further comprises:
a gas discharge channel connected to said downstream end; and
a purge valve that is disposed in said gas discharge channel and is capable of being opened and closed to switch the state of communication of the gas discharge channel.

8. The fuel cell according to claim 1, wherein the fuel cell further comprises:
a gas discharge channel connected to said downstream end; and
a throttle valve disposed in said gas discharge channel.
